(19) United States
(12) Patent Application Publication
(10) Pub. No.: US 2004/0240318 A1
(43) Pub. Date: Dec. 2, 2004

(54) Method for improved bubble curtains for seismic multiple suppression

(75) Inventors: Evelyn N. Drake, Bernardsville, NJ (US); Eric B. Sirota, Flemington, NJ (US); Seven E. Heiney, Houston, TX (US); Warren S. Ross, Houston, TX (US); Donald N. Schulz, Annandale, NJ (US); Hans Thomann, Bedminster, NJ (US)

Correspondence Address: EXXONMOBIL UPSTREAM RESEARCH COMPANY, P.O. Box 2189, Houston, TX, 77252-2189, US

(73) Assignee: EXXONMOBIL UPSTREAM RESEARCH COMPANY, Houston, TX

(21) Appl. No.: 10/816,510

(22) Filed: Apr. 1, 2004

Related U.S. Application Data
(60) Provisional application No. 60/471,008, filed on May 16, 2003.

(51) Int. Cl. G01V 1/387

(52) U.S. Cl. 367/15; 367/24

(57) ABSTRACT

A method and apparatus for slowing the rise of air bubbles for large-scale applications such as bubble curtains for suppressing noise in marine seismic surveys. Bubble rise time is increased by a chemical additive which either retards bubble coalescence or produces smaller bubbles through wetting agent properties, or a combination of both.

This application claims the benefit of U.S. Provisional Application No. 60/471,008 filed on May 16, 2003.

### FIELD OF THE INVENTION

This invention relates generally to the field of geophysical prospecting and more particularly to suppression of multiple reflections in seismic data gathering. Specifically, the invention is a method and apparatus for chemical extension of bubble rise time in bubble curtains used for seismic multiple suppression.

### BACKGROUND OF THE INVENTION

The use of a bubble curtain to block unwanted seismic noises in seismic data is the subject of a companion patent application with Lee et al. as inventors and with PCT publication number WO 02/50755, Jun. 27, 2002. Other patents involving use of bubble layers for seismic acquisition purposes include U.S. Pat. No. 5,959,938 to Behrens, U.S. Pat. No. 4,625,302 to Clark, U.S. Pat. No. 5,401,921 to D'Antonio, U.S. Pat. No. 4,618,024 to Domenico, and G.B. U.S. Pat. No. 1,376,513 to Rupert, et al.

Since a seismic vessel is moving, bubbles cannot be continuously emitted from bubble making devices at one location. Therefore, after the bubbles are emitted from the bubble making devices, they must stay in the water long enough to suppress noise throughout the duration of the seismic experiment, or at least a significant part of that experiment. If the bubbles rise out of the water too rapidly, they will have only a negligible effect on the seismic wave. The problem in seismic data acquisition is particularly challenging because seismic waves have very long wavelengths and the seismic apparatus covers many square kilometers. Hence the bubble curtain must cover a very large area, while a seismic vessel is traveling away from the point of bubble emission at typically 2 m/s (4 knots) or more.

Bubble rise rate is controlled at least partially by bubble size (the other critical factor is fluid dynamic viscosity). Smaller bubbles rise slowly because the drag forces on the bubble are better able to counterbalance their buoyancy. By contrast, larger bubbles rise more rapidly, with rise rate being proportional to the square of bubble radius. The key to keeping bubbles in the water longer, therefore, is to make them small and ensure that they stay as small as possible. Bubbles have a tendency to coalesce and form larger bubbles. Behrens recognized that for seismic purposes bubbles should preferably be produced small, and coalescence should preferably be inhibited.

For seismic applications, the primary means proposed to make small bubbles has been to control the dimensions, geometry and distribution of the orifices emitting bubbles from, for example, a PVC tube. (Ceramic (silicate) bubble emitters make very small bubbles, but are much too brittle for seismic applications.) The disclosures in the Behrens patent and in the Clark patent referenced above are two examples of this. Similarly, Behrens's method for retarding coalescence is based on strategic positioning of the apertures in the bubble emitter. Such methods have limited effectiveness for seismic applications. An improved method is needed for producing small bubbles and retarding coalescence and which would be effective in saltwater environments and be practical for large-scale seismic application. The present invention satisfies these needs.

### SUMMARY OF THE INVENTION

In one embodiment, the present invention is a method for increasing the rise time of air bubbles emitted from a diffuser in water for the purpose of suppressing noise in a marine seismic survey. This is accomplished by delivering a chemical additive, selected for its bubble coalescence retardation properties, at or near the surface of the diffuser. Preferred chemical additives are identified. In another embodiment, the introduction of the chemical additive is accomplished by coating the diffuser with the chemical additive. In another embodiment, the diffuser is preconditioned by soaking it in salt water before coating it with the additive. In yet another embodiment, the diffuser is given a second coating of chemical additive. Besides chemical additives that retard bubble coalescence, additives that are wetting agents are used in other embodiments of the invention also to increase bubble rise time. In one of the embodiments, a wetting agent is added into the diffuser material during the diffuser manufacturing process.

In another embodiment, the chemical additive is introduced by mixing it in with the air within the diffuser before the bubbles are emitted. An apparatus for carrying out such a method is yet another embodiment of the present invention.

### BRIEF DESCRIPTION OF THE DRAWINGS

The present invention and its advantages will be better understood by referring to the following detailed description and attached drawings in which:

FIG. 1 illustrates an apparatus for delivering bubble rise-time-extending additives;

FIG. 1A is a flow chart illustrating one process for extending bubble rise time by topcoating the bubble emitter surface;

FIGS. 1B and 1C illustrate how contact angle is measured for determinations of wettability of a particular surface;

FIG. 2 illustrates an apparatus for optical measurement of bubble rise time;

FIGS. 3-8 illustrate the effect of different coalescence-retarding chemical additives on bubble rise time in salt water;

FIG. 9 compares the different additives from FIGS. 3-8 at varying concentrations in terms of their effect on bubble rise time;

FIG. 10 illustrates the effect of Exxal-13, applied as a diffuser hose topcoat, on bubble rise time in salt water;

FIG. 11 illustrates the effect on bubble rise time of a second topcoating with Exxal-13;

FIG. 12 illustrates the effect of Pluronic L81, applied as a diffuser hose topcoat, on bubble rise time in salt water;

FIGS. 13-16 illustrate the effect of different poly(oxyalkylene) block polymer additives on bubble rise time in salt water; and

FIG. 17 compares the different additives from FIGS. 13-16 at varying concentrations in terms of their effect on bubble rise time.

The invention will be described in connection with its preferred embodiments. However, to the extent that the following detailed description is specific to a particular embodiment or a particular use of the invention, this is intended to be illustrative only. On the contrary, it is intended to cover all alternatives, modifications, and equivalents that are included within the spirit and scope of the invention, as defined by the appended claims.

### DETAILED DESCRIPTION OF THE PREFERRED EMBODIMENTS

The current invention increases bubble curtain lifetime by chemical methods.

Outside the seismic field, applications exist in which there is benefit in making small gas bubbles (air or other gas). Food processing, metals production, biotechnology and waste removal from aquifers are examples. In these applications, small bubbles cause gases to have higher total contact surface area to volume ratio with the fluid, thus facilitating absorption and other chemical reactions. In these non-seismic areas, chemical methods of making bubbles small are well known. The following publications are representative of those that discuss the chemical fundamentals of the process of making small bubbles (in non-seismic applications):

Chem. Eng. Sci. 17, 87 (1962) “Gas Absorption by Large Rising Bubbles”;

I&EC Fundamentals 6, 233 (1967) “Behavior of Air Bubbles In Dilute Aqueous Solutions”;

I&EC Process Design and Development 8(1), 69 (1969) “Effects of chemical additives on performance of an air-water contactor”;

Foams, R. J. Akers ed., Academic Press, p.147 (1976) “Bubble coalescence in aqueous solutions of n-alcohols”;

Chem. Eng. Sci. 37, 11(1982) “Inhibition of bubble coalescence by solutes in air/water dispersions”;

Int. J. Multiph. Flow 13, 4 (1987) “(An experimental and theoretical study of) bubble behavior in a three-phase fluidized bed”;

J. Colloid Interface Sci. 174, 1 (1995) “Observations of solute effects on bubble formation”;

Phys. Rev. E: Stat. Phys., Plasmas, Fluids, Relat. Interdiscip. Top. 54, 6 (1996) “Deformation of fluid interfaces under double-layer forces stabilizes bubble dispersions”;

J. Phys. Chem. B 102, 26 (1998) “Inhibition of Bubble Coalescence in Aqueous Solutions. 1. Electrolytes”;

Chem. Eng. Sci. 54, 21(1999) “The effect of surface-active additives on bubble coalescence in aqueous media.”

Patents involving the use of chemical additives to inhibit bubble coalescence include:

Hsueh, Limin, Hard, Robert A., Davidson, Donald H., Huff, Ray V., 1977, In-situ mining of copper and nickel, U.S. Pat. No. 4,045,084;

Fischer, Albert K.; Johnson, Carl E., 1980, Method of foaming a liquid metal, U.S. Pat. No. 4,183,744;

Muskat, Josef, 1982, Biological purification of wastewater:

German Patent DE 3101566;

Sethna, Rustam H., Athalye Atul M., Sahm, Michael K., 1997, Gas injection apparatus and method having application to gold leaching, U.S. Pat. No. 5,645,771.

The distinctive features of these non-seismic applications are quite different from seismic applications, however. The non-seismic applications are characterized by relatively small volumes (square meters, at most, vs. square kilometers) and lack of motion. Motion is critical. For the seismic application, not only are very large surface areas traversed, but the motion itself places demands on the method of distributing the chemical: Large quantities of the chemical are very costly, and so efficient distribution is critical. Furthermore, the motion itself wears parts, introduces dispersion of the chemicals and causes difficulty in keeping chemicals where they are needed. One further distinction is that many of the non-seismic applications are in fresh (or at least relatively non-briny) water. Some of the studies outside the seismic area have concentrated on the effects of salts on bubble size, for example:

Chem. Eng. Sci. 22,1257 (1967) “Coalescence of gas bubbles in aqueous solutions of inorganic electrolytes”;

Chem. Eng. Sci. 26, 509 (1971) “Behavior of gas bubbles in aqueous electrolyte solutions”;

I&EC Fundamentals 10, 260 (1971) “Bubble coalescence and gas transfer in aqueous electrolyte solutions”;

Nature 364, 317 (1993) “Effect of electrolytes on bubble coalescence.”

Fortuitously, the presence of dissolved salts in water tends to reduce bubble size. The present invention provides significant further reduction of bubble size which allows the bubble curtain invention of Lee and other similar seismic applications to realize more of their inherent potential. The present invention accomplishes reduction in bubble size by chemical methods. Chemical additives have been found which reduce air bubble size in salt water for bubbles emitted from a microporous bubble maker creating a bubble curtain for seismic multiple suppression. The additives include, but are not limited to, surfactants, alcohols, acids, esters, ethers, sugars and mixtures thereof. Additives similar to some of these have been used in other (non-seismic) applications to reduce bubble size for the purpose of better oxygen or other gas transfer to water. The present invention, however, addresses problems not present in those other applications, namely the distribution of size-reducing additives in the vicinity of a moving, high air-flow-rate bubble curtain generator to enhance seismic multiple suppression in seismic data collection.

Preferred chemical additives according to the present invention include n-propanol, 2-ethyl hexanol, octanol, ExxonMobil Chemical Exxal-8 alcohol, ExxonMobil Chemical Exxal-9 alcohol, ExxonMobil Chemical Exxal-13 alcohol and sodium dodecyl sulfate. ExxonMobil chemicals are available from ExxonMobil Chemical Company, 13501 Katy Freeway, Houston, Tex. 77079-1398. Other chemicals may be obtained from standard chemical supply sources. These additives all have the property of inhibiting bubble coalescence in salt water to a greater or lesser degree, depending on concentration and chemical structure. For example, as discussed further below, 0.0001 weight percent of 2-ethyl hexanol will double the rise time of a bubble column and the same weight percent of Exxal-9 will more than triple the rise time. At higher concentrations, the effect is more pronounced: 0.01 weight percent of 2-ethyl hexanol will quadruple the rise time of a bubble column and the same weight percent of Exxal-9 will quintuple the rise time.

Methods and apparatus for administration of the additives to salt water in the vicinity of the diffuser (“diffuser” is a term used to refer to whatever bubble emitter device is employed) and the region between the diffuser and the air-water interface are also a subject of this invention. Such methods include pumping, spraying, dispersing or otherwise mixing the additives into salt water in the vicinity of the diffusers. Additives may also be pumped, injected, vaporized or sucked into the compressed air stream prior to passage through the diffusers. This embodiment of the present invention effectively uses the compressed air stream to deliver additive in the vicinity of the diffuser. Finally, additives may be directly applied to and/or absorbed into the surface of the diffuser (“topcoating”) for slow release into salt water in its vicinity. An additional feature of the present invention is a method of pre-treating the hoses by multiply coating them to make the effect long-lasting when directly applied in a manner that is further described below.

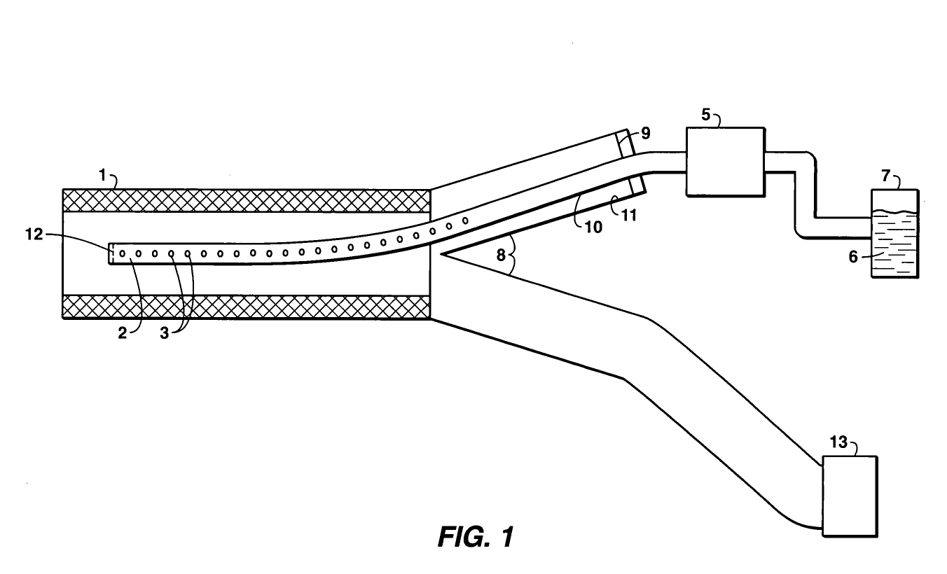

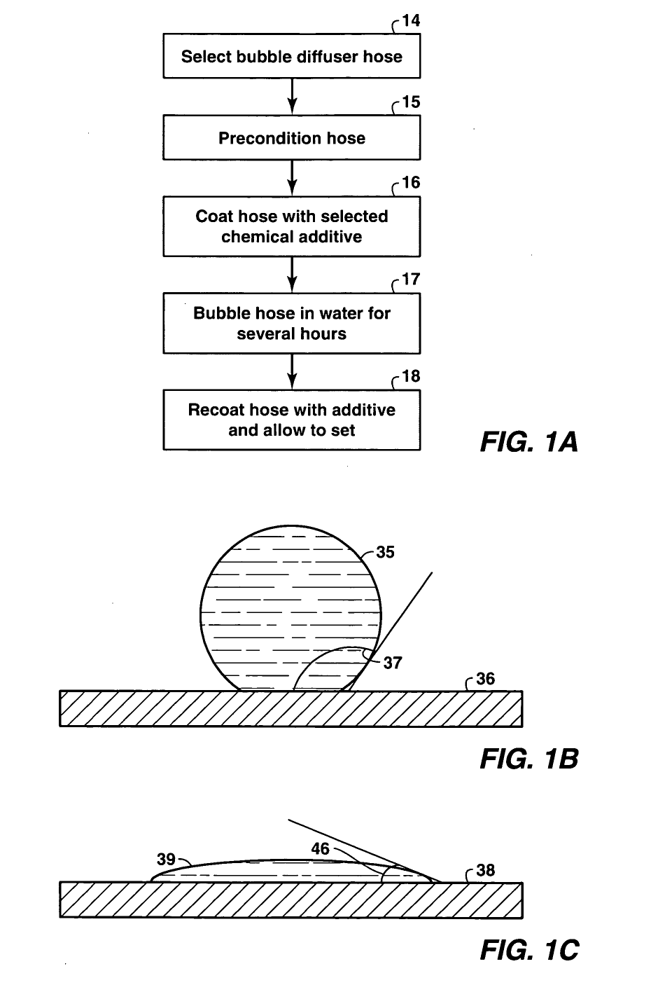

One particular embodiment of the present invention is depicted in FIG. 1. The apparatus includes an inner tube 2 inserted inside of the bubble diffuser hose 1 (shown in cross section). Tube 2 has a sufficiently small diameter compared to outer hose 1 that it can easily fit inside the outer hose, allowing unobstructed air flow around tube 2. Tube 2 further contains perforations 3 at intervals such as every half inch along its length, from which bubble-size-reducing additive can escape and be delivered along the entire length of the hose 1, emerging from hose 1 along with the air through micropores (not shown) located at intervals along hose 1, and thus producing the bubble-size-reducing effect described above. Tube 2 is connected to a pump 5 and a source of bubble-size-reducing additive 6 in a holding tank 7. Pump 5 has a controlled flow rate for delivering a selected amount of bubble-size-reducing additive 6 per unit volume of air.

Tube 2 is inserted into the bubble diffuser hose 1 through one leg of a “Y” conduit 8, which leg is closed off at 9 by epoxy or other means such that air injected into the other leg of the “Y” does not escape from the region between the outer surface 10 of tube 2 and the inner surface 11 of the “Y” 8. The other leg of the “Y” is connected to a compressor or other source of compressed air 13. Tube 2 is also closed off by epoxy or other means at end 12 to stop the bubble-size-reducing additive from escaping out that end, and thereby forcing it to emerge from the pinholes 3, and ultimately to emerge with the air through the micropores in tube 2. The presence of the bubble-size-reducing additive at the site of the bubble formation through the micropores causes desired bubble-coalescence inhibition and hence the bubble-size reducing effect described above. This method is appropriate for those additives on the lower viscosity end of the spectrum of additives listed above (or mixtures of these additives in low viscosity diluents), and it may result in clogged pores for the more viscous additives.

In alternative embodiments of the present invention, the air injection approach includes the step of atomizing the additive into very fine droplets prior to delivery into the diffuser. (Such an atomizer is not shown in FIG. 1.) Tests have demonstrated that alcohols such as Exxal-8 can in fact be atomized into droplets of average diameter of 0.3 microns or smaller. Atomization of the additive facilitates its transport through the fine pores of the diffuser, tending to prevent clogging of pores. Tests have shown that atomized Exxal-8 at 8 psi (with admixed air) passes through pores of a diffuser hose where the pore surface diameter varied between 3 and 30 microns. No clogging problem was observed. This is not to imply that the apparatus of FIG. 1 with no atomization capability will not be able to deliver an additive such as Exxal-8 into the outside water. Nevertheless, as the viscosity of the additive increases, delivery rates through the tiny pores necessary to create tiny bubbles suffer, and clogging tends to exacerbate the problem. Atomization is a partial answer to this limitation. Persons skilled in the art will know many ways to atomize liquids into very fine droplets. They include, without limitation, twin fluid devices, piezoelectric devices, flash boiling, nebulizing and electrospray atomization. All such methods are intended to be within the scope of the present invention.

Other methods of distributing the chemical additive, besides direct addition to the salt water and the method illustrated in FIG. 1, are part of the present invention and are discussed below, including application directly to the hose surface.

Because of the movement of the apparatus in a marine seismic survey, the total volume of water to be filled with bubbles by the system is very large. It might seem at first as though the total volume of additive needed would be prohibitive. The amount is, indeed, large in some delivery methods. However, it is a feature of the present invention (see example section below) that very low concentrations of some of the additives disclosed herein yield significant beneficial effects. The issue of possible environmental impact in an ocean environment should be addressed in connection with any application of the present invention. With respect to this concern too, the small quantities of chemical additive required, especially in certain embodiments of the present invention, provide good reason to expect a favorable assessment. Also, some of the additives disclosed herein have low to moderate environmental impact because they are relatively nontoxic and rapidly degrade.

As mentioned previously, existing approaches to bubble making for seismic applications concentrate on making smaller bubbles by improving the geometry and spatial distribution of the pores in the bubble-making device. In fact, the value of small bubbles is diminished if the bubbles tend to coalesce right above the bubble emitter pores. The net effect in such a case is the creation of large bubbles that rise faster. Such short-duration bubble curtains will give poor results in large area applications such as seismic applications. Bubble coalescence inhibition therefore emerges as a factor of comparable importance to bubble emission size in creating a bubble curtain with fine bubbles. The combination of the two factors is preferred to make a bubble curtain that lasts a long time in a moving seismic experiment.

FIG. 1A is a flow-chart of an embodiment of the present inventive method using a different approach to introducing the chemical additive than was shown in FIG. 1. This embodiment is among the preferred embodiments from the standpoint of balancing all of the requirements of a suitable bubble-coalescence-inhibiting additive—including acceptable total volume of coverage for both cost and environmental reasons, as well as effectiveness.

In step 14, a bubble diffuser in the form of a hose is selected. The rubber “weeping” hose manufactured by various companies for water irrigation or other purposes is one possibility. One such manufacturer, Fiskars, Inc., constructed an experimental prototype called the “B2-type experimental hose” for the present inventors. This hose is ¼ inch ID and ½ inch OD.

In step 15, the hose is preconditioned by soaking or bubbling in fresh or salt water for a prolonged period such as 24 hours. This preconditioning helps to stabilize hose performance.

In step 16, the surface of the preconditioned hose is coated with a selected chemical additive such as one of the additives disclosed herein, for example ExxonMobil Exxal-13 diluted 50% in ethanol. Exxal-13 has an isomeric composition as follows: Major isomers are tetramethyl-1-nonanols, trimethyl-1-decanols, and trimethyl-1-nonanols, Carbon number distribution: 7% C11, 30% C12, 60% C13, 3% C14. Preferably, two coats are applied. The quantity of active Exxal-13 to apply for this first coating is at least 0.04 g/inch of hose. Application to small quantities of hose is preferably by paintbrush. Surface should be shiny but not dripping, and it should be allowed to set for at least 5 minutes before use. Application to larger quantities of hose can be via dunking in a tray or vat of Exxal-13, or by spraying Exxal-13, in each case with Exxal-13 diluted in a suitable solvent.

In step 17, the treated hose is operated (air is bubbled from it) in salt water for a prolonged period of time, such as 24 hours or more.

In step 18, the hose is re-coated with 50% ethanol-diluted Exxal-13, applying at least 0.06 gram of active Exxal-13 per inch of hose, and then is allowed to set at least 5 minutes before use.

The B2-type experimental hose supplied by Fiskars is an experimental version of commercially available weeping hose used by the fisheries industry to oxygenate fish tanks. This particular hose is a preferred bubble maker for the purposes of the present invention in that it makes small bubbles of approximately 100-300 microns radius with suitable flow rates of approximately 0.3 cubic feet per minute per foot of hose. This bubble size range is achieved after the hose has been preconditioned as disclosed above in step 15. Other elastomeric or polymeric materials besides rubber also work well in diffuser hoses. There are other bubble makers with commercial suppliers that make finer bubbles, but many have undesirably low flow rates, are possibly too fragile for seismic use or are considerably more costly. The topcoating with Exxal-13 effectively retards the natural coalescence of the bubbles as they emerge from the relatively closely spaced micropores of the B2 hose. The effect lasts at least 24 hours when the multiple coating prescribed above is applied. A similar effect can be achieved by topcoating with other additives identified herein, particularly the longer-chained chemical additives (chain length of approximately 8 or more).

Tests conducted by the present inventors indicate that the reduction in bubble rise time due to an additive such as Exxal-13 is not solely due to that additive's effect on bubble coalescence. Exxal-13 also acts as a wetting agent, promoting air bubble detachment by increasing the water wettability of the surface of the air-dispersing device. The more rapidly air bubbles detach from the surface, the smaller their size. This effect is particularly important in the case of the rubber-filled polyethylene soaker hose discussed above. The polyethylene surface is very hydrophobic (water-repelling) in the absence of a wetting agent, and therefore tends to hold on to air bubbles. When additives known to be stronger wetting agents than Exxal-13 were tested, they were found to extend bubble rise time.

A particularly effective class of wetting agents for the purpose of the present invention has been found to be poly(oxyalkylene) block copolymers composed of ethylene oxide (EO) and propylene oxide (PO) blocks of the following general structures: (EO)ₓ(PO)_{y}(EO)ₓ and (PO)_{y}(EO)ₓ(PO)_{y}. Particular examples that were found to work were obtained from BASF Corporation. Their product names are Pluronic L81, L64, L62, and 25R2. The chemical structure of Pluronic L81, L64 and L62 consists of a long block of polypropylene oxide in the center and shorter blocks of polyethylene oxide attached to each end as follows:

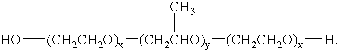

Pluronic 25R2 has a reverse chemical structure consisting of a short block of polyethylene oxide in the center and longer blocks of polypropylene oxide attached to each end:

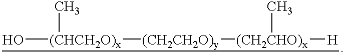

The average molecular weight and number of ethylene oxide (EO) and propylene oxide (PO) units in each material are given in the following table:

| | | X (EO | Y (PO |
|---|---|---|---|
| | Ave. MW | units) | units) |
| L81 | 2750 | 6 | 39 |
| L64 | 2900 | 13 | 30 |
| L62 | 2500 | 8 | 30 |
| 25R2 | 3500 | 14 | 44 |

A range of poly(oxyalkylene) block copolymers are available commercially with the number of EO units ranging from 2 to 128 and PO units ranging from 16 to 67. All of these are expected to be wetting agents and therefore to give positive results as the chemical additive in the present invention. This is not intended to exclude other wetting agents. For example, known wetting agents include, without limitation, polyoxybutylene-polyoxyethylene block copolymers, sodium dioctylsulfosuccinate, sodium di-(2-ethylhexyl) sulfosuccinate, disodium dodecyloxypropyl sulfosuccinimate and sodium dodecylbenzene sulfonate.

The contact angle of a water droplet on a solid surface is a measure of the water “wettability” of that surface. The smaller the contact angle, the more wettable the surface. FIGS. 1B and 1C illustrate how this angle is measured. In FIG. 1B, the water droplet 35 is not wetting the surface 36 well, and the result is a high contact angle 37 of 130°. By contrast, FIG. 1C shows a different surface 38 which water wets very well. Consequently, the water droplet 39 is flattened and spread out and the contact angle 46 is only 20°.

Three 1.5×0.5×0.07 inch thick coupons were made from the linear low density polyethylene (LLDPE) pellets used in the manufacture of the rubber-filled polyethylene porous hose used in the tests described herein. LLDPE is the external phase of the composite and therefore the polymer on the hose surface. The coupons were cleaned with isopropanol. Five drops of distilled water were applied to different regions of the surface of the first coupon, and contact angles were measured with a Video Contact Angle System of AST Products, Inc. The average contact angle of distilled water on clean LLDPE was 104±2.6 degrees. A thin coating of Pluronic L81 was applied from a 25 wt % solution in ethanol to the surface of the second coupon, and the ethanol was allowed to evaporate. Five drops of distilled water were applied to different regions of the surface. The average contact angle of distilled water on Pluronic L81 coated polyethylene was 7.8±2.5 degrees. A thin coating of Exxal-13 alcohol was applied from a 25 wt % solution in ethanol to the surface of the third coupon, and the ethanol was allowed to evaporate. The average contact angle of distilled water on Exxal-13 coated polyethylene was 67±2.6 degrees. These data show that both Pluronic L81 and Exxal-13 increase the wettability of LLDPE, but Pluronic L81 has a much stronger effect. The wettability potential of any additive may be assessed by measuring the contact angle in this fashion. As noted previously, Exxal-13 slows bubble rise due to both the wetting agent property and the bubble coalescence retardation property. Additives which strongly adsorb onto the surface of the bubble diffuser are the most likely to exhibit this dual effect.

The effect of contact angle on bubble size, and that contact angle depends on the composition of the diffuser are known, but in non-seismic applications. For example, N. Ueno, “Effect of porous materials on the generation and the growth of bubbles in aeration,” Ceramic Transactions 31, 343-352 (1993); and U.S. Pat. No. 5,422,043 to Burris (1995). Ueno and Burris also understood that the diffuser surface may be treated to decrease the contact angle.

### EXAMPLE

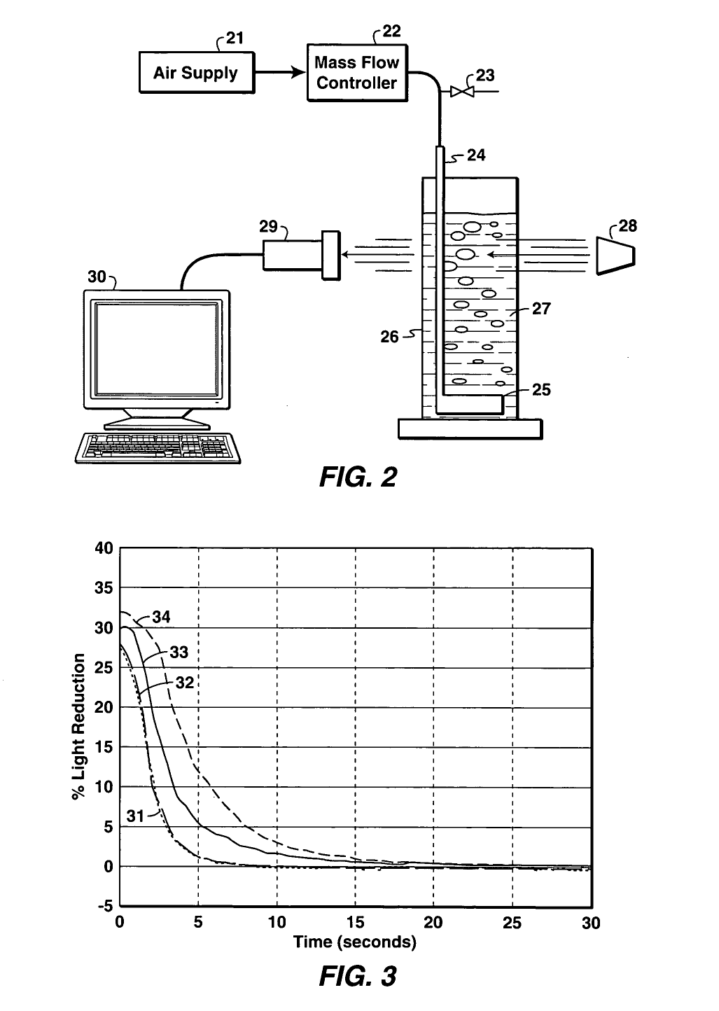

In order to demonstrate the present invention, the apparatus shown in FIG. 2 was constructed to quantify bubble rise time in salt water. The apparatus consisted of an air supply 21, mass flow controller 22, control valve 23, air delivery tube 24, fine hose diffuser 25, glass cylinder 26 containing test solution 27 (containing the chemical additive to be tested), white light source 28, photodiode detector 29 and computer 30. Test solutions with varying concentrations of additives were prepared in synthetic salt water made from 40 grams per liter of sea salt (Sigma) in distilled water. The glass cylinder was cleaned and filled with test solution. Background light level was recorded with the photodiode detector. Airflow then was established at a constant rate of 318 cc/min/inch of diffuser hose with a mass flow controller and passed through a diffuser consisting of a one-inch segment of the porous rubber hose planned for use in the field. Light level at full airflow was recorded. Then airflow was abruptly stopped by opening the control valve, causing air to be diverted from the diffuser. Light intensity was recorded as air bubbles rose to the surface of the cylinder. Data is plotted in most of the following figures as per cent light reduction versus time. Time zero corresponds to the time air was diverted from the diffuser. The smaller the air bubbles in a particular test solution, the longer the rise time.

The test apparatus of FIG. 2 also serves to illustrate another mode of the present invention which may be described as bulk addition of the additive, as contrasted with the air injection mode illustrated by FIG. 1 and the topcoating mode outlined in FIG. 1A.

Plots showing variation in bubble rise time (in terms of percent light reduction) with bulk concentration of n-propanol, 2-ethyl hexanol, octanol, ExxonMobil Chemical Exxal-8 alcohol, ExxonMobil Chemical Exxal-9 alcohol and sodium dodecyl sulfate in salt water are given in FIGS. 3-8.

FIG. 3 shows the effect of n-propanol in varying concentrations on bubble rise time in salt water. Curve 31 shows saltwater with no additive. Curve 32 shows the effect of adding 0.01% n-propanol; the effect is slight, and curve 32 is difficult to distinguish from curve 31. Significant rise time increases are seen, however, for 0.1% concentration of n-propanol (curve 33) and for 1% concentration (curve 34).

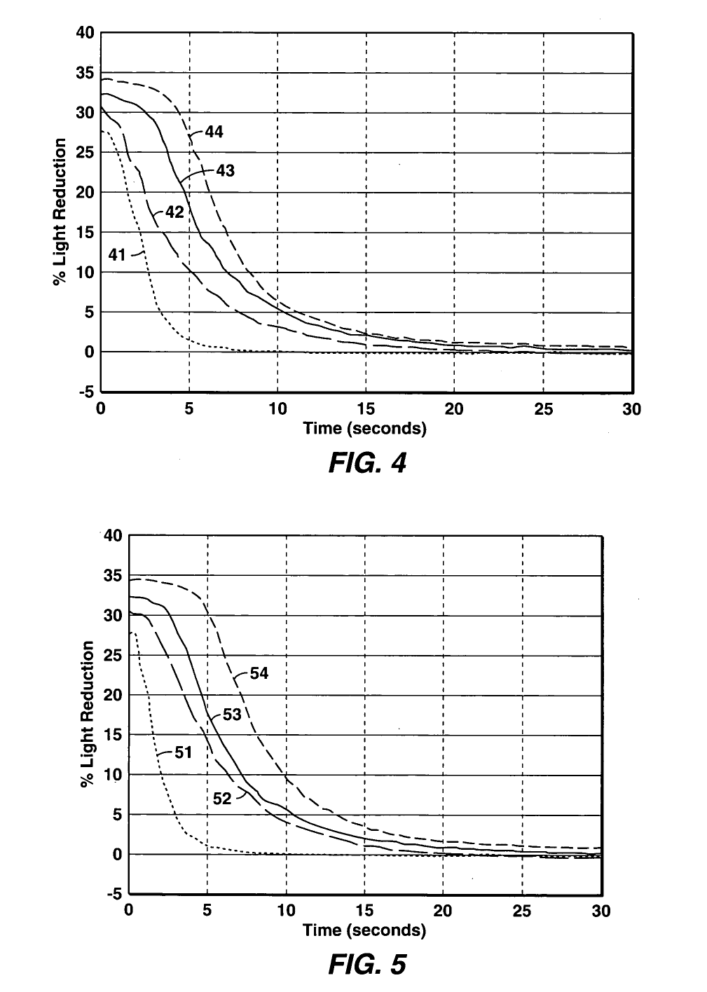

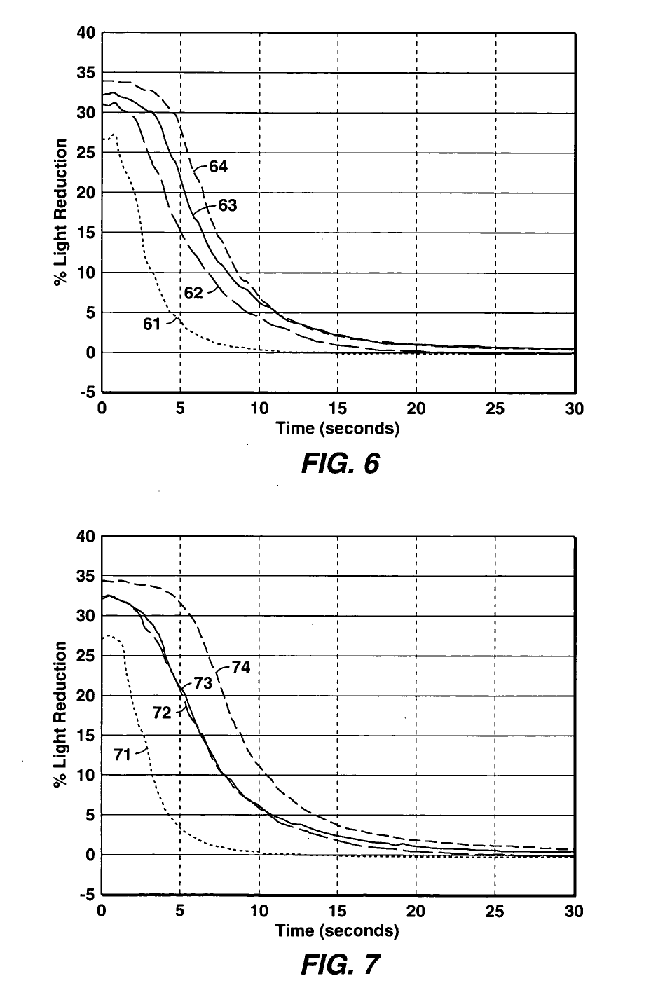

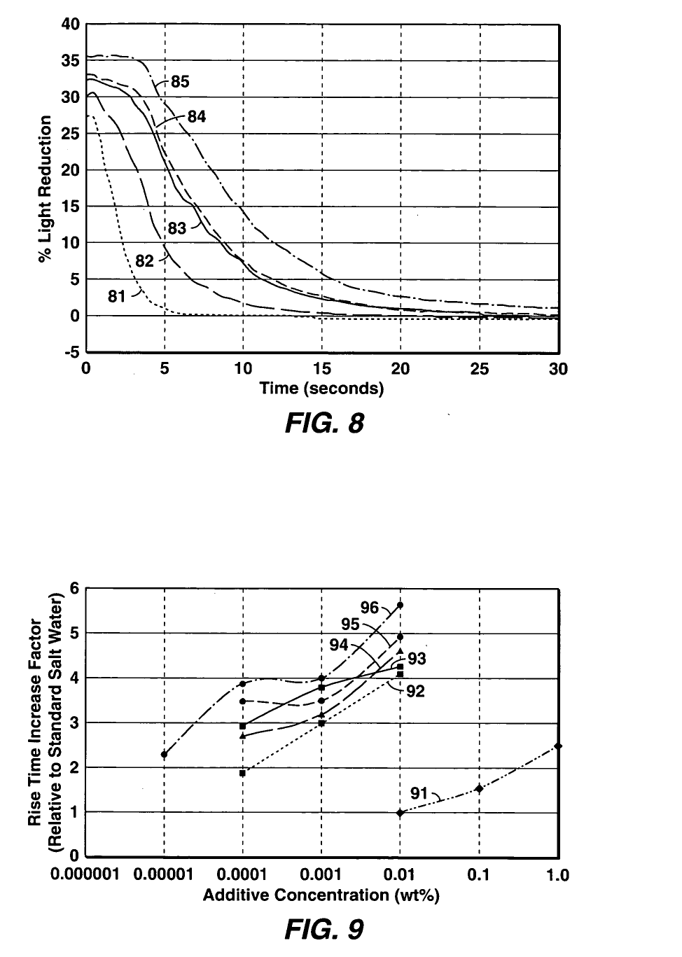

In FIG. 4, the additive is 2-ethyl-1-hexanol, and the concentrations are 0% (curve 41); 0.0001% (curve 42); 0.001% (curve 43); and 0.01% (curve 44). In FIG. 5, the additive is octanol, and the concentrations are 0% (curve 51); 0.0001% (curve 52); 0.001% (curve 53); and 0.01% (curve 54). In FIG. 6, the additive is Exxal-8, and the concentrations are 0% (curve 61); 0.0001% (curve 62); 0.001% (curve 63); and 0.01% (curve 64). In FIG. 7, the additive is Exxal-9, and the concentrations are 0% (curve 71); 0.0001% (curve 72); 0.001% (curve 73); and 0.01% (curve 74). In FIG. 8, the additive is sodium dodecyl sulfate, and the concentrations are 0% (curve 81); 0.00001% (curve 82); 0.0001% (curve 83); 0.001% (curve 84); and 0.01% (curve 85).

A combined plot of rise time increase at 15% light reduction as a function of additive type and concentration is given in FIG. 9. Rise time increase was calculated by dividing the time required for a particular additive to reach 15% light reduction by the time required to reach 15% light reduction in pure salt water. In each case the presence of additive increased bubble rise time. The higher the molecular weight of the additive, the stronger the effect. Additive molecules with branched hydrocarbon side chains (for example, Exxal-8) as well as those with linear hydrocarbon side chains (e.g., octanol) were effective. The higher the concentration, the stronger the effect. The additives graphed in FIG. 9 are propanol (91); 2-ethyl-1-hexanol (92); Exxal-8 (93); octanol (94); Exxal-9 (95); and sodium dodecyl sulfate (96). Selection of the best additive for use in the field will depend on cost, performance, and toxicity to marine organisms.

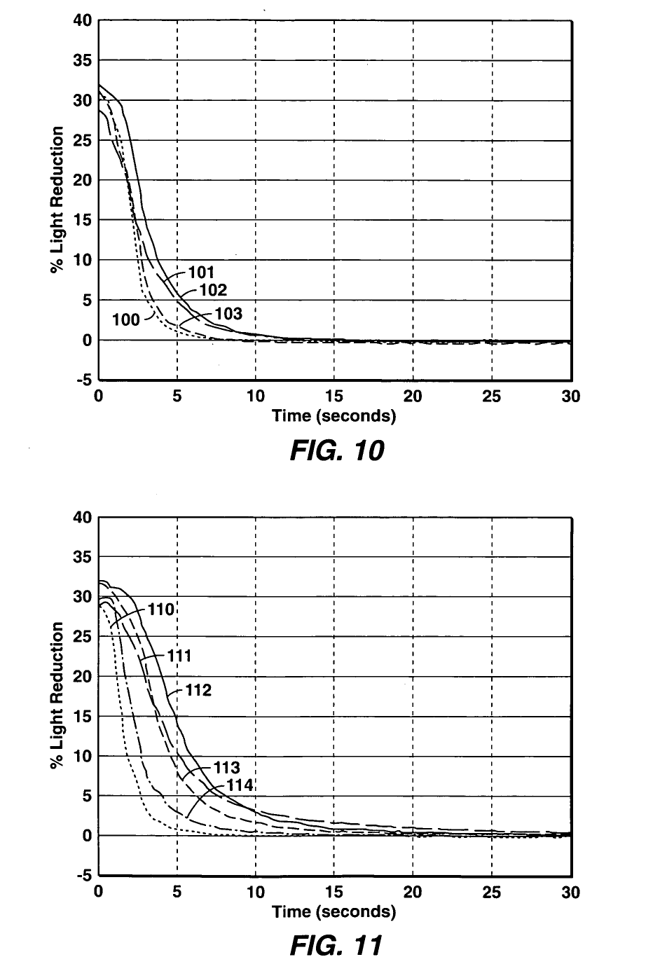

FIGS. 10 and 11 show the results of topcoating the hoses with Exxal-13. The test set-up was that of FIG. 2, with the fine hose diffuser 25 being pre-coated. The parameter in each FIG. (10 and 11) is time of continued operation. These figures also demonstrate the method of multiply coating the hoses for extending the effect of topcoating, which only lasts an hour or two without this second coating, and is substantially less in magnitude. FIG. 10 shows data for a 0.04 g/inch Exxal-13 topcoat on a hose that was not pre-treated. Curve 101 shows the bubble rise time after 0.25 hours of operation, curve 102 after 2.25 hours, and curve 103 after 20.5 hours. Curve 100 shows the bubble rise time with no topcoating. FIG. 11 shows data for a 0.059 g/inch topcoat of Exxal-13 on the previously coated hose in FIG. 10. Curve 111 shows bubble rise time after 0.25 hours of operation, curve 112 after 1.5 hours, curve 113 after 3.5 hours and curve 114 after 20.5 hours. Curve 110 shows the bubble rise time before application of a second topcoat, i.e., after the first topcoating and with 20.5 hours of run time in salt water, at which point performance had nearly returned to baseline. For both figures, the Exxal-13 was diluted in 50% Ethanol to facilitate evenness of coating. The results show that the second coating causes the bubble lifetime at 1.5 hours to be 3.3 times baseline and at 3.5 hours to be 2.5 times baseline. This compares with a bubble lifetime increase for the first coating at 2.25 hours of only 1.35. At 20 hours, the first coating causes bubble lifetime to increase by only 6% whereas the second coating causes bubble lifetime to increase by 50%. In both cases, immediately after coating there is a short-term negative effect from topcoating, a few minutes to 15 minutes. One benefit of the second coating is that it reduces the duration of this negative effect. Additional coatings may extend this effect.

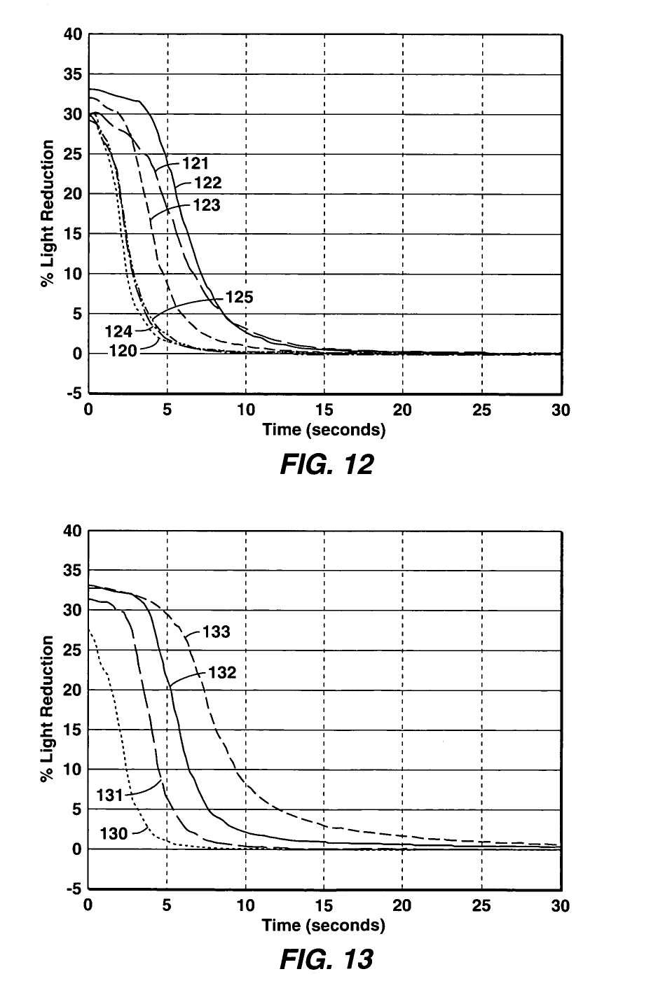

FIG. 12 shows the effect of topcoating the porous rubber-filled polyethylene hose with the BASF Pluronic L81 poly(oxyalkylene) block copolymer. The coating was 0.075 grams of active Pluronic L81 per inch of hose, from a 50 wt. % solution in ethanol. Before topcoating, the hose was conditioned (a preferred but not necessary step) by bubbling in distilled water for 23 hours and in salt water for 46 hours. The coating was allowed to set for 10 minutes before use. The results were plotted as in FIGS. 10 and 11. Curve 121 shows the bubble rise time profile at the beginning of operation, curve 122 similarly corresponds to 5 minutes of continuous bubbling in salt water, curve 123 to 1.5 hours, curve 124 to 4.5 hours, and curve 125 to 20.3 hours. Curve 120 represents the hose with no topcoating, for a baseline reference. (A comparison of curves 121 and 122 shows the short-term negative effect mentioned previously.) The salt water was refreshed between data points in order to minimize the effect of dissolved Pluronic L81 in the solution. Rise time at 15% light reduction was increased relative to baseline by a factor of 3 after 5 minutes. After 1.5 hours, it was 1.9×baseline, and after 4.5 hours it had returned nearly to baseline. Comparing FIG. 12 to FIG. 10 shows that Pluronic L81 is more effective at slowing bubble rise time than Exxal-13 when applied as a hose topcoat, despite the dual mechanisms operating in Exxal-13.

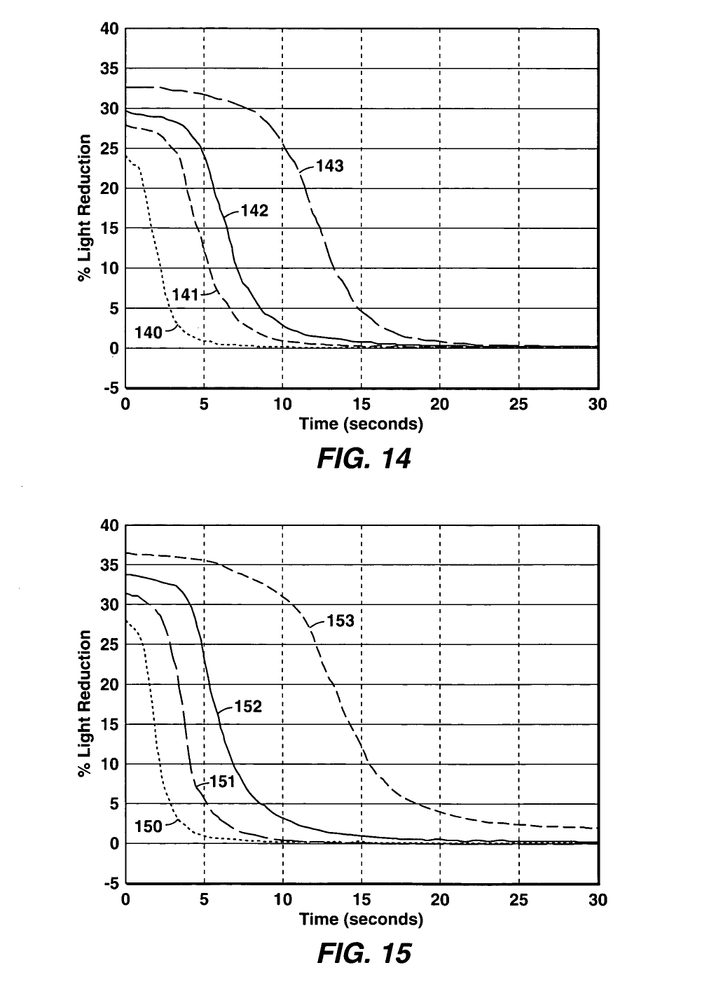

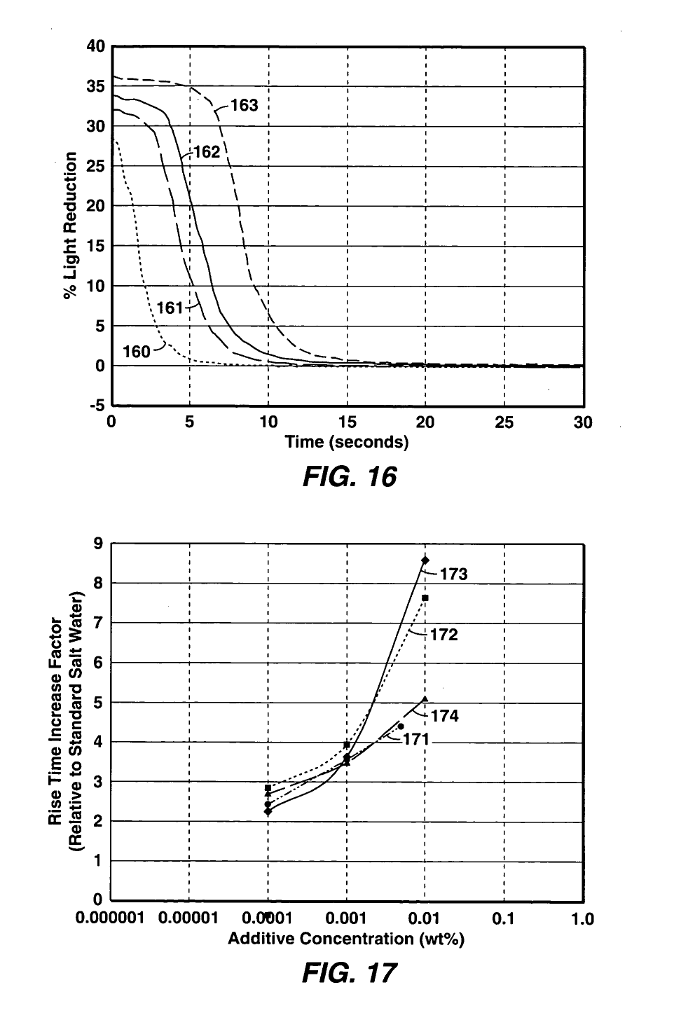

Direct addition of various poly(oxalkylene) block copolymers to salt water was tested using the apparatus depicted in FIG. 2. Bubble rise time was measured in salt water solutions containing varying concentrations of Pluronic L81 (FIG. 13); L64 (FIG. 14); L62 (FIG. 15); and 25R2 (FIG. 16). Plots of light reduction vs. time for each additive are shown in the indicated figures. Airflow in the diffuser hose was maintained at the constant rate of 318 cc/min/inch of hose, i.e., 318 cc/min for the one-inch length of hose used in the apparatus of FIG. 2. In FIG. 13, curve 130 represents zero concentration of L81, curve 131 represents a concentration of 0.0001 wt %; curve 132 represents 0.001%; and curve 133 represents 0.005%. In FIG. 14, the concentrations of L64 are zero (curve 140), 0.0001% (curve 141), 0.001% (curve 142), and 0.01% (curve 143). In FIG. 15, the concentrations of L62 are zero (curve 150), 0.0001% (curve 151), 0.001% (curve 152), and 0.01% (curve 153). In FIG. 16, the concentrations of 25R2 are zero (curve 160), 0.0001% (curve 161), 0.001% (curve 162), and 0.01% (curve 163). A combined plot of rise time increase at 15% light reduction as a function of additive type and concentration is given in FIG. 17. Curve 171 corresponds to additive L81, curve 172 to L64, curve 173 to L62, and curve 174 to 25R2. The y-axis in FIG. 17 is a rise time increase factor, calculated by dividing the time required for a particular additive to reach 15% light reduction by the time required to reach 15% light reduction in pure salt water (zero concentration of additive). In each case, the presence of the additive increased bubble rise time. The higher the concentration of additive, the stronger the effect. At the higher concentrations (0.001% and 0.01%), significant amounts of foam appeared on top of the solutions of L64 and L62, an undesirable feature for use in the field. In addition to this factor, selection of the best additive for use in the field will depend on cost, performance and toxicity considerations.

Because of the possible environmental concerns discussed previously, yet another embodiment has been conceived for the present invention. In this embodiment, the wetting agent is directly incorporated into the diffuser during the fabrication process. This has been tested by adding a wetting agent during the extrusion (manufacturing) process for a porous hose composed of rubber and LLDPE (linear low density polyethylene). Wetting agents were added as pre-pelletized blends in LLDPE or a similar polyolefin to facilitate mixing in the extruder. Liquid wetting agents were not added directly into the extruder. 2 and 5 wt % blends of Pluronic L81 in LLDPE were utilized or pelletized blends of 15 wt % VF-150 fatty glyceride and 20 wt % VW-351 functionalized silicone wetting agent concentrates in polyolefin from Polyvel, Inc. Contact angle tests on blends of the wetting agents in LLDPE prior to incorporation into the hose gave positive results, but bubble rise-time tests of the modified hoses were inconclusive. It appears that the wetting agents were adsorbed onto the dispersed rubber phase or partially degraded during the extrusion process, or both. It is believed that this embodiment can be made successful by a combination of (1) keeping the temperature low enough during the extrusion process to ensure that the additives are not thermally degraded during extrusion, and (2) ensuring that the additives do not adhere to the rubber particles, which are fully encapsulated in the interior of the LLDPE. This would allow the additives to be available on the surface of the hoses, which is LLDPE, rather than rubber. (The hoses tested were composed primarily of rubber (˜60%) and LLDPE (˜40%).)

The foregoing description is directed to particular embodiments of the present invention for the purpose of illustrating the invention. It will be apparent, however, to one skilled in the art that many modifications and variations of the embodiments described herein are possible. For example, the invention is described and tested in salt water because that will be its predominant seismic application; however, it will work as well in fresh water. In addition to the additives identified hereinabove, dissolved salts may also be used in fresh water applications. Further, it is intended that any additive that extends the rise time of bubbles in water is within the scope of the present invention, whether the effect be due to creating smaller bubbles or retarding bubble coalescence or a combination thereof. All such modifications and variations are intended to be within the scope of the present invention, as defined in the appended claims.

We claim:

1. A method for increasing the rise time of air bubbles emitted from a diffuser in water for the purpose of suppressing noise in a marine seismic survey, said method comprising the step of coating the diffuser before use with a chemical additive having bubble coalescence retardation properties or wetting agent properties or both.

2. The method of claim 1, wherein the chemical additive is Exxal-13 diluted in ethanol.

3. The method of claim 1, wherein the chemical additive is chosen from among the following: 2-ethyl-1-hexanol, octanol, Exxal-8, Exxal-9, Exxal-13, and sodium dodecyl sulfate.

4. The method of claim 1, wherein the chemical additive is a poly(oxyalkylene) block copolymer composed of ethylene oxide (EO) and propylene oxide (PO) blocks having any of the following general structures: (EO)ₓ(PO)_{y}(EO)ₓ and (PO)_{y}(EO)ₓ(PO)_{y}, where x is in the approximate range 2-128 and y is in the approximate range 16-67.

5. The method of claim 4, wherein the chemical additive is chosen from among the following: Pluronic L81, Pluronic L62, Pluronic L64, and Pluronic 25R2.

6. The method of claim 1, wherein the diffuser is a perforated hose made from polymeric or elastomeric material.

7. The method of claim 1, further comprising the step of preconditioning the diffuser by soaking or bubbling it in fresh or salt water before coating it.

8. The method of claim 1, further comprising the steps of operating the diffuser in water followed by recoating the diffuser with a chemical additive having bubble coalescence retardation properties.

9. A method for increasing the rise time of air bubbles emitted from a diffuser in water for the purpose of suppressing noise in a marine seismic survey, said method comprising the step of mixing a chemical additive in with the air within the diffuser before the bubbles are emitted, said chemical additive having bubble coalescence retardation properties or wetting agent properties or both.

10. The method of claim 9 comprising the additional step of atomizing the chemical additive.

11. The method of claim 9, wherein the chemical additive is chosen from among the following: n-propanol, 2-ethyl-1-hexanol, octanol, Exxal-8, Exxal-9, Exxal-13, and sodium dodecyl sulfate.

12. The method of claim 9, wherein the chemical additive is a poly(oxyalkylene) block copolymer composed of ethylene oxide (EO) and propylene oxide (PO) blocks having any of the following general structures: (EO)ₓ(PO)_{y}(EO)ₓ and (PO)_{y}(EO)ₓ(PO)_{y}, where x is in the approximate range 2-128 and y is in the approximate range 16-67.

13. The method of claim 12, wherein the chemical additive is chosen from among the following: Pluronic L81, Pluronic L62, Pluronic L64, and Pluronic 25R2.

14. A method for increasing the rise time of air bubbles emitted from a diffuser in water for the purpose of suppressing noise in a marine seismic survey, said method comprising the step of injecting a chemical additive into the water in the region where the bubbles are emitted from the diffuser, said chemical additive having bubble coalescence retardation properties.

15. The method of claim 14, wherein the chemical additive is chosen from among the following: n-propanol, 2-ethyl-1-hexanol, octanol, Exxal-8, Exxal-9, Exxal-13, and sodium dodecyl sulfate.

16. A method for increasing the rise time of air bubbles emitted from a diffuser in water for the purpose of suppressing noise in a marine seismic survey, said method comprising the step of injecting a chemical additive into the water in the region where the bubbles are emitted from the diffuser, said chemical additive having wetting agent properties.

17. An apparatus for creating a bubble layer in water, comprising:
a) a bubble diffuser tube having small openings through which compressed air can be emitted, one end of said diffuser tube being closed, and the other end forking into a Y-conduit, said Y-conduit having a first Y-tube and a second Y-tube, said second Y-tube being adapted for connecting to an air compressor; and
b) an inner tube having a closed end inserted closed end first through the end of the first Y-tube and on into the bubble diffuser tube, said inner tube extending through an opening in an air-tight seal placed at the end of the first Y-tube and being adapted for connecting outside the first Y-tube to the output end of a pump.

18. The apparatus of claim 16, further comprising a pump connected at its output end to the end of the inner tube extending beyond the first Y-tube and connected at its input end to a holding tank suitable for holding a chemical additive having bubble coalescence retardation properties.

19. A method for increasing the rise time of air bubbles emitted from a diffuser in water for the purpose of suppressing noise in a marine seismic survey, said method comprising mixing a chemical additive having wetting agent properties into the diffuser during fabrication.

20. The method of claim 19, wherein the diffuser is a perforated rubber and linear low density polyethylene (LLDPE) hose and the additive is introduced in pellets comprised of Pluronic L81 blended into LLDPE, Polyvel VF-150 fatty glyceride wetting agent concentrate, or Polyvel VW-351 functionalized silicone wetting agent concentrate.
